(19) United States
(12) Patent Application Publication
(10) Pub. No.: US 2008/0147525 A1
(43) Pub. Date: Jun. 19, 2008

(54) CPU Banking Approach for Transactions Involving Educational Entities

(76) Inventors: Gene Allen, Vandais Heights, MN (US); Michael Beier, Lakeville, MN (US); Kevin Kuntz, South St. Paul, MN (US)

Correspondence Address: CRAWFORD MAUNU PLLC, 1150 NORTHLAND DRIVE, SUITE 100, ST. PAUL, MN, 55120, US

(21) Appl. No.: 11/956,611

(22) Filed: Dec. 14, 2007

Related U.S. Application Data
(63) Continuation-in-part of application No. 11/156,256, filed on Jun. 16, 2005.
Application No. 11/156,256 is a continuation-in-part of application No. 11/640,118, filed on Dec. 15, 2006.
(60) Provisional application No. 60/875,019, filed on Dec. 15, 2006.
(60) Provisional application No. 60/580,818, filed on Jun. 18, 2004.
(60) Provisional application No. 60/836,767, filed on Aug. 10, 2006.

(51) Int. Cl. G06Q 40/00

(52) U.S. Cl. 705/30; 705/35

(57) ABSTRACT

In an example embodiment, an approach for financial transaction processing involves using regulatory type rules at a banking institution for processing financial transactions involving a non-banking financial institution, such as a funds transfer service. An assimilation processing module and underlying processing modules determine whether the funds-transfer request should be reported as at least one of funds-related activity involving the banking institution and funds-related activity involving the financial institution.

### RELATED PATENT DOCUMENTS

This patent document claims benefit, under 35 U.S.C. § 119(e), of U.S. Provisional Patent Application No. 60/875,019 filed on Dec. 15, 2006 and entitled: “CPU Banking Approach for Transactions Involving Educational Entities.” This patent document also claims benefit under 35 U.S.C. §120 to common subject matter of U.S. patent application Ser. No. 11/156,256, entitled “CPU Banking Approach for Transactions Involving Non-Banking Entities,” filed on Jun. 16, 2005 (TCFB.005PA), and which claims benefit under 35 U.S.C. §119(e) to U.S. Provisional Patent Application No. 60/580,818, entitled “CPU Banking Approach for Transactions Involving Non-Banking Entities,” filed on Jun. 18, 2004 (TCFB.005P1) and to U.S. patent application Ser. No. 11/640,118, entitled “Computer-Facilitated Account-Transaction System and Method Therefor” filed on Dec. 15, 2006 (TCFB.025PA), which claims benefit under 35 U.S.C. §119(e) to U.S. Provisional Patent Application No. 60/836,767, entitled “Computer-Facilitated Account-Transaction System and Method Therefor,” filed on Aug. 10, 2006 (TCFB.025P1). Each of these patent documents is fully incorporated herein by reference

### FIELD OF THE INVENTION

The present invention relates generally to the assimilation of computer-generated data for automated compliance with financial transaction reporting.

### BACKGROUND

Financial institutions provide account services to account holders using a variety of interfaces, such as web interfaces, tellers and automated teller machines (ATMs). These interfaces allow for multiple access points and otherwise facilitate access to one or more accounts held by the account holders. Similarly educational institutions provide account services to students, faculty, staff, alumni or others with an appropriate relationship with the university. The accounts can be typically accessed through web interfaces or through computers (e.g., specialized computer kiosks) provided by the educational institution. Such computers require an investment in initial funding and maintenance costs by the educational institution.

Users with an account at both a financial institution and an educational institution often desire to move funds from one account to the other. Such transfers can be difficult to effect because the individual typically needs to access the accounts separately and use some mechanism to transfer the funds between the accounts. For instance, some educational institutions allow for funds to be deposited in an account through checks, credit cards and cash deposits. Such methods often require the individual to access both accounts individually (e.g., to withdraw cash for depositing in another account) or to deal directly with a person who accepts the transfer of funds. Directly dealing with a person often limits the account holder to normal business hours and can cost the institution funds because the institution pays for the employees to process the account transfers.

Large banking institutions operate using large databases and computer systems adapted to handle thousands of accounts and many transactions. Recent laws including the Patriot Act, Anti-money Laundering Act (AML) and the Bank Secrecy Act (BSA) discussed further below have required banks to research ways to adopt increasingly complex banking systems in order to mitigate the misuse of its systems in violation of a myriad of rules that apply to transactions.

When a business relationship involves banking and non-banking institutions, such as non-banking financial institutions, each party in the relationship needs to coordinate efforts in a manner that is not burdensome to either party's systems (e.g., CPU based systems). In addition, where compliance-type reporting to government agencies is required, it is desirable to process information for compliance reporting that is not confusing for an agency receiving the report.

A multitude of financial institutions operate under a variety of different conditions. These conditions may include, for example, geographic conditions as relating to a particular region, state, or country, or to other geographic conditions. Accordingly, state, federal, and international rules that apply to these financial institutions may vary. Other conditions specific to an institution or institutions may also apply, such as those relating to a particular business approach or business relationship between entities participating in a transaction.

In many instances these different conditions present challenges to the operation and maintenance of financial transactions. For example, where a banking institution provides funds for use in a transfer by a non-banking financial institution, both the banking institution and the non-banking financial institution will typically function under different conditions. The rules and laws that apply to each institution typically vary as to reporting requirements for a variety of compliance issues. In addition, the banking and non-baking financial institutions may operate under different conditions based on each institution's business practices, geographical location, or other trait.

As discussed above, a variety of regional, state, national, and international rules may apply to financial transactions and to the institutions involved in the transactions. For example, the Currency and Foreign Transactions Reporting Act, also known as the Bank Secrecy Act (BSA), and its implementing regulation, 31 CFR 103, is a tool that the U.S. government uses to combat drug trafficking, money laundering, and other crimes. Money laundering is the criminal practice of filtering ill-gotten gains or “dirty” money through a series of transactions so that the funds are “cleaned” to look like proceeds from legal activities. Cash does not need to be involved in every stage of the laundering process, and almost any transaction conducted at a bank may constitute money laundering.

Congress enacted the BSA to prevent banks and other financial service providers from being used as intermediaries for, or to hide the transfer or deposit of money derived from criminal activity. The reporting and recordkeeping requirements of the BSA regulations create a paper trail for law enforcement to investigate money laundering schemes involving financial institutions. Financial institutions involved in transactions falling under these regulations must be implemented using the corresponding BSA reporting and recordkeeping requirements.

Amendments to the BSA in 1986 strengthened the U.S. Government's ability to fight money laundering by making it a criminal activity. In 1994, legislation required regulators to develop enhanced examination procedures and increase examiner training to improve the identification of money laundering schemes in financial institutions. Therefore, banks must educate its employees, understand its customers and their businesses, and have systems and procedures in place to distinguish routine transactions from ones that rise to the level of suspicious activity.

On Oct. 26, 2001, the Uniting and Strengthening America by Providing Appropriate Tools Required to Intercept and Obstruct Terrorism Act of 2001 (USA PATRIOT Act) was signed into law. The International Money Laundering Abatement and Financial Anti-Terrorism Act of 2001 (the Act) is Title III of the USA PATRIOT Act and contains provisions that affect national banks most directly. In general, Title III amended the Bank Secrecy Act and gave federal regulators significant new powers to obtain information from a wide range of financial service and other companies and contained the broadest reforms of U.S. anti-money-laundering since 1994.

The above and other acts and regulations have presented challenges in complexity and compliance for banking and non-banking financial institutions.

Meeting the above conditions, associated requirements and other transaction-related issues has been challenging, particularly where two or more institutions are involved in financial transactions such as those involving funds transfer.

### SUMMARY

The present invention is directed to overcoming the above-mentioned challenges and others related to the types of applications discussed above and in other applications, such as those related to government-related compliance issues. These and other aspects of the present invention are exemplified in a number of illustrated implementations and applications, some of which are shown in the figures and characterized in the claims section that follows.

According to an example embodiment of the present invention, compliance requirements are implemented using an approach involving coordination between banking and non-banking financial institutions which participate in a financial transaction. Compliance reports are generated as a function of information from both of the banking and non-banking institutions.

The above summary is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention that follows in connection with the accompanying drawings, in which:

FIG. 1 shows a financial transaction system, according to an example embodiment of the present invention;

FIG. 2 shows a financial transaction arrangement, according to another example embodiment of the present invention; and

FIG. 3 shows a process flow diagram for financial transaction processing, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention is believed to be applicable to a variety of different types of devices, processes, and approaches, and has been found to be particularly suited for the financial transactions involving a banking entity and a non-banking financial institution. While the present invention is not necessarily limited to such applications, various aspects of the invention may be appreciated through a discussion of examples using this context.

According to an example embodiment of the present invention, an approach for financial transaction processing involves using regulatory type rules at a banking institution for processing financial transactions involving a non-banking financial institution, such as a funds transfer service.

In another example embodiment of the present invention, a transaction approach involves compliance with government-related requirements, such as those involving money-laundering and/or other reporting type functions. The approach involves using policies and procedures applicable to a non-banking financial institution, such as a money transfer institution for use with issues such as those related to national security and money laundering. In some instances, other policies mutually implemented by the banking institution and non-banking financial institution are also used. In other instances, banking institution-based and non-banking financial institution-based compliance monitoring/processing functions are implemented concurrently.

Compliance reporting functions are carried out for a variety of applications. General reporting for compliance purposes may be carried out using a compliance monitoring report (CMR) as can be implemented, for example, with funds transfer entities. Where government reporting is required for activities deemed suspicious (e.g., potentially illegal or otherwise dangerous), a suspicious activity report (SAR) is generated. The SAR is generated as a function of banking institution-based rules and, in some instances as discussed above, also as a function of non-banking financial institution-based rules. Examples of activities that may be subject to monitoring (for suspicious activity or otherwise), as well as approaches to determining whether an activity needs to be monitored, include the following:
Single-transaction monetary limit (transactions over a particular limit are flagged for monitoring)
Combined transaction monetary limit (combined transactions involving a particular entity over a particular limit are flagged for monitoring—these combined transactions may be further monitored as a function of time over which the transactions occur)
Multiple currency transactions
Individual or entity identity (e.g., using identification numbers, state or government issued identification, passport, alien identification or drivers license number, date of birth, occupation and address of a sender or receiver of money, and/or lists including individuals or entities singled out, such as for national security or criminal purposes, for monitoring by a government or other agency)
Wires in and wires out (both foreign and domestic)
Cash in and cash out involving depository accounts (e.g. where a 13 week period of cash transactions affecting a depository account exceeds $30,000)
Number of automated clearing houses affecting an account
Number of automated telling machines used to deposit or withdraw funds from an account

Each of the above-referenced activities can be monitored using approaches that may be implemented using combinations of the above activities or other activities. For instance, multiple currency transactions can be monitored for conditions relating to a single-transaction monetary limit. In addition, a variety of historical type data approaches may be implemented for monitoring some or all of these activity monitoring approaches. For instance, a local database may be used to keep historical data for a business entity or individual. Shared databases may also be used, where the shared databases may be maintained by a government type agency.

In some applications, a SAR and/or CMR are generated as a function of a combination of activities from a banking institution and a non-banking financial institution. In these instances, a reporting approach involves the banking institution monitoring SAR-related and/or CMR-related processes and generating a report therefrom.

In another example embodiment of the present invention, a transaction management approach for a transaction involving banking and non-banking financial institutions addresses compliance needs by providing records of the non-banking financial institution to the banking institution. The records are used to address reporting requirements for banking institutions, such as for generating currency transaction reports.

In another example embodiment of the present invention, an interface is provided for use by an agent of a banking or non-banking institution involved in a transaction, or by an individual effecting the transaction (e.g., effecting a money transfer using an automated teller machine). In addition, the interface is programmed to generate data used in compliance reporting. The data may be generated, for example, using compliance requirement rules for one or both of a banking institution and a non-banking financial institution, or using one or more of the many approaches discussed herein. Such an interface may be configured to notify the agent or individual of the reporting status of the transactions. For instance, the agent or individual can be asked to confirm a transaction that would otherwise be flagged as suspicious. The agent or individual could also be notified that the transaction has such an elevated status and of the possible consequences. Often the agent or individual will be unaware that their activity would otherwise be view as suspicious. This can be particularly useful for reducing the amount of suspicious activity that occurs.

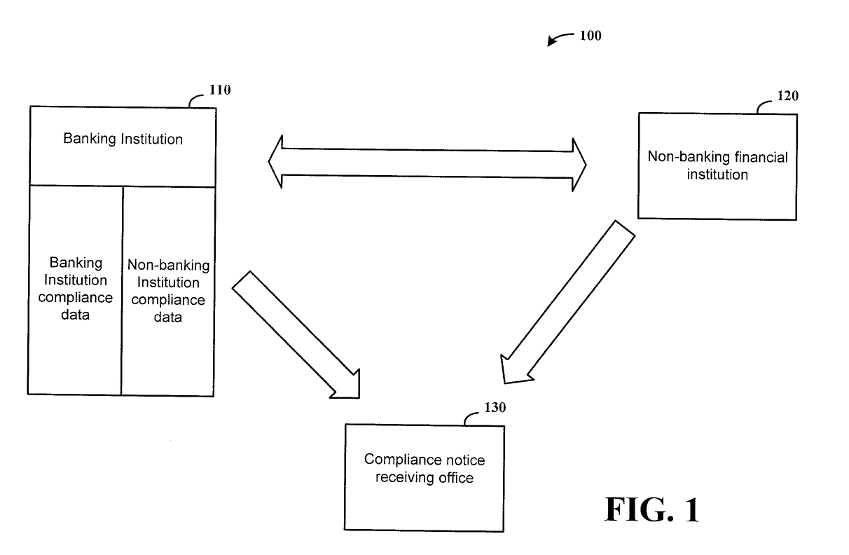

Turning now to the figures, FIG. 1 shows a system 100 for implementing a compliance-based processing approach among transactions involving a banking institution 110 and a non-banking financial institution 120, according to another example embodiment of the present invention. Compliance functions are carried out as a function of rules associated with the transaction and typically involve the selective communication of information to a compliance notice receiving office 130, such as a government entity (e.g., a security or tax entity). In some implementations, the compliance functions are consistent with one or more government-related security rules or Acts, such as the above-discussed Homeland Security Act.

The banking institution 110 typically implements a computer-based approach for processing transactions. Information for banking and non-banking institution compliance is stored at the banking institution 110. The computer-based approach and related transaction processing generally involves the use of compliance information for maintaining records (e.g., historical) and/or generating reports for transactions that fall into a category that is regulated or otherwise of interest to the compliance notice receiving office 130. Where government-type compliance rules or Acts are implemented with the computer-based approach, edicts associated with compliance rules or Acts applicable to a transaction are automatically implemented with a computer (i.e., the computer is programmed to process transactions in accordance with the edicts).

The non-banking institution 120 (e.g., a money transfer institution) generally processes transactions in accordance with its proprietary rules as well as in accordance with regulatory rules applicable to the particular transaction being processed. In some instances, these regulatory rules are implemented with the banking institution 110, where recordkeeping and reporting type functions can be carried out. When a particular regulatory rule dictates that a transaction requires recordkeeping or reporting when certain criteria are met, the banking institution 110 carries out these requirements upon detecting or discovering satisfying criteria. Such regulatory rules may dictate the tracking of transactions for a particular customer where those transactions individually and/or cumulatively meet criteria that falls under reporting requirements. Other rules may involve reporting customer information to the compliance notice receiving office 130 when a transaction or transactions meet selected criteria.

In other instances, where some or all aspects of regulatory rules applicable to the banking institution 110 and to the non-banking institution 120 overlap, functions such as recordkeeping and/or reporting are coordinated. For example, where a particular transaction involves characteristics applicable to homeland security compliance rules for both banking and non-banking institutions, recordkeeping and/or reporting is coordinated to avoid redundancy. In this instance, where the compliance notice receiving office 130 is to be notified of a transaction condition, only one of the banking and non-banking institutions notifies the reporting agency of the transaction condition.

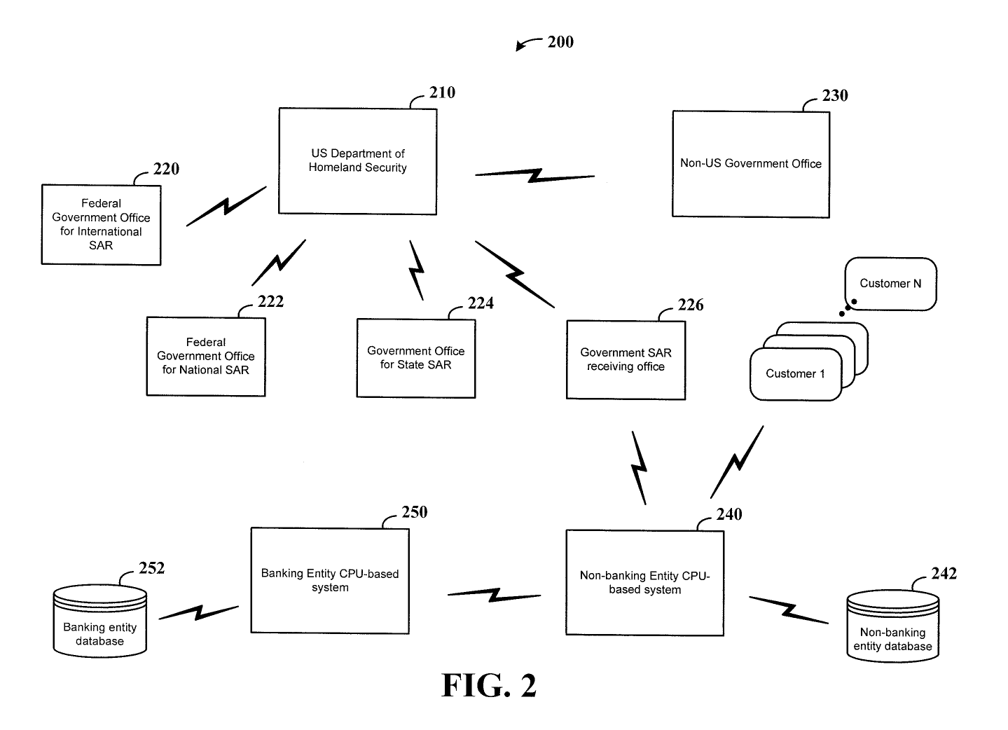

FIG. 2 shows an arrangement 200 for processing financial transactions, according to another example embodiment of the present invention. The arrangement 200 is implemented with a banking entity and a non-banking entity. The banking entity employs a banking entity CPU-based system 250 and a database 252, which may be implemented together as shown by a zig-zag line. The non-banking entity employs a non-banking entity CPU-based system 240 and a database 242, which may also be implemented together as shown by a zig-zag line. These banking and non-banking entities process transactions in accordance with government regulations, shown by way of example here as being related to a security department 210 (labeled the US Department of Homeland Security for illustrative purposes).

The security department 210 communicates with one or more of a plurality of government offices 220-226, as well as with one or more non-government offices (represented in FIG. 2 by office 230, yet applicable to more offices). Here, the shown government offices include a federal government office for international SAR 220, a federal government office for national SAR 222, a state government office for state SAR 224 and a government IRS SAR receiving office 226. Other government offices are implemented as applicable. The banking entity CPU-based system 250 communicates with one or more of the government offices as shown, and the non-banking entity CPU-based system communicates with the government IRS SAR receiving office 226 (and may further communicate with other offices, depending upon the implementation).

The non-banking entity database 242 includes information used by the non-banking entity CPU-based system 240 in processing transactions. For example, customer and transaction information for customers 1-N of the non-banking entity can be stored in the database 242 and made readily accessible for transaction processing. The banking entity database 252 also includes a variety of information, with the type and content of the information depending upon the implementation. For example, customer accounts, compliance regulations, customer transaction information and reconciliation information for banking and non-banking entities are selectively stored in the banking entity database 252.

When a customer (represented by one of customers 1 through N) does business with the non-banking entity, information regarding the customer is received at the non-banking entity CPU-based system 240. When the customer uses the banking entity for funding purposes, compliance rules applicable to the banking entity are followed. Based on banking entity compliance reporting rules in the non-banking entity database 242, the non-banking entity CPU-based system 240 generates compliance information for the banking entity CPU-based system 250. The banking entity CPU-based system 250 in turn uses the generated compliance information with rules in its database 252 to generate a compliance report for one or more of the government offices 220-226. The generated compliance report includes compliance-type information for the banking institution and, in some instances, for the non-banking institution. In an alternate (or supplemental) approach, upon discovery of a condition that may be susceptible to compliance reporting, the banking institution CPU-based system 250 may generate a notice to the non-banking entity CPU-based system 240, which in turn can use the notice to generate a compliance report.

In some applications, one or more of the databases 242 and 252 are used to store historical financial data, based on users or other criteria. This historical data is used for compliance monitoring purposes, such as for ensuring time-related compliance or for identifying individuals or entities subject to certain types of monitoring.

In another implementation, one or more of the banking entity or non-banking entity CPU-based systems 250 and 240 (or a separate system) are implemented for reconciling information for a variety of purposes. The reconciliation may involve, for example, individual or entity name reconciliation, where a variation in individual or entity name can occur between different transactions. In this regard, when transactions are monitored over time, variations in names for common transaction entities are reconciled such that transactions involving a particular entity are commonly tracked irregardless of the variation. For example, transactions involving a person using “John Smith” and “J. Smith” and having the same address can be reconciled under a common person for tracking and compliance purposes. As another example, a person known to use certain aliases may be tracked using a database that lists and links the aliases; when two different transactions involve different names that are related aliases, the transactions are reconciled.

Reconciliation may also involve timing reconciliation, wherein transaction events occur at locations having different time zones, or wherein transaction processing is at a time zone different from a time zone where transaction events occur, such as where a money transfer is effected from one time zone to another. In this regard, when compliance requirements involve fund transfer amounts during a particular time period (such as during a business day), timing information for a transaction is reconciled to a standard time that can be used to assess whether a particular transaction would exceed a fund limit over a particular time period. For example, where the banking entity CPU-based system 250 receives transaction information from the non-banking entity CPU-based system 240 that indicates a transaction initiation time, that time is reconciled to a time relevant to the location of the banking and non-banking entities. For instance, where the non-banking entity is in a time zone that is two hours ahead of the time zone of the banking entity, the banking entity CPU-based system 250 automatically reconciles the timing of a transaction by subtracting two hours from the time indicated by the non-banking entity.

In another approach, reconciliation involves currency reconciliation for determining a relevant amount of funds that can be used for comparison to fund limits or for adding with other funds for other transactions involving a particular entity. Referring again to FIG. 2, where the non-banking entity processes a funds-transfer request that is in a currency different from a currency upon which compliance monitoring is based, the funds-transfer request is reconciled to the currency upon which compliance monitoring is based. Similarly, when two or more transactions involving a particular entity involve the transfer of funds in different currencies, one or more of the funds transfers is reconciled into a currency such that both transfers are comparable in a common currency. These currency-based approaches may involve the use of rules for making currency translations for standardizing compliance monitoring.

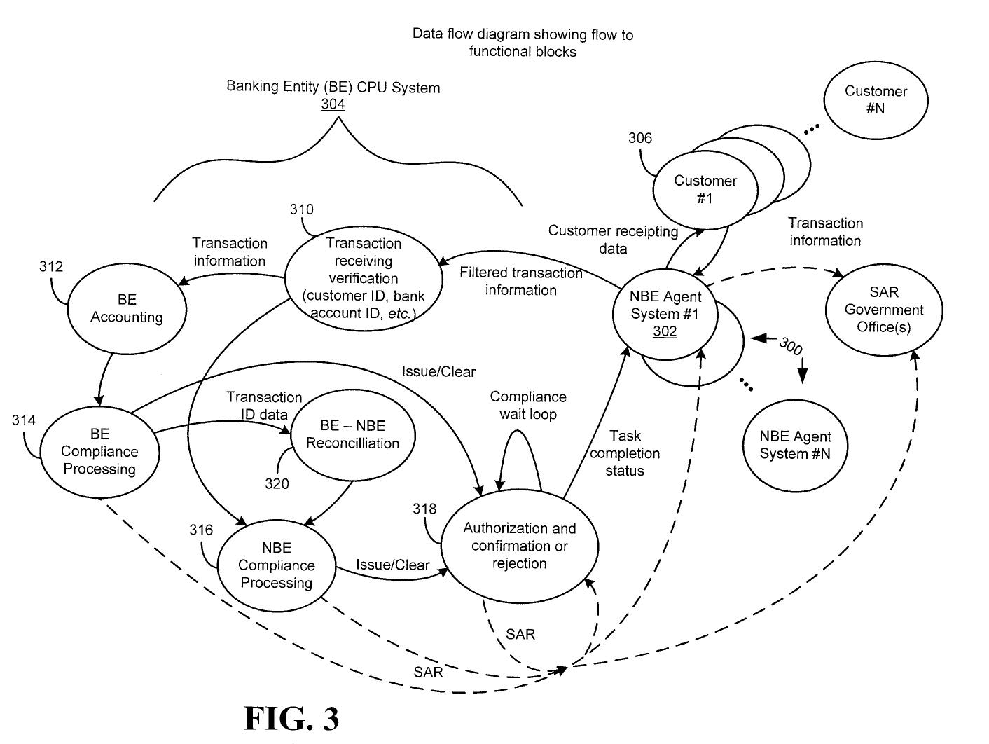

FIG. 3 is a data-flow diagram for an example application involving one or more financial institutions 300, including at least one nonbanking entity 302, and a banking entity having a CPU system (“BE CPU system”) 304.

The BE CPU system 304 is configured to process banking transactions using computer systems that access relatively large databases for client-related information (e.g., account numbers, access codes and signature samples, contact data and the like). For certain larger banking entities, this processing includes accessing data for tracking accounts held by authorized branch offices and by various types of banking-partners such as financial institutions 300 that have been pre-authorized to participate. In some instances involving such a larger banking entity, a branch office of the banking entity acts as an agent for the nonbanking entity 302.

The relevant functional aspects of such an arrangement are shown in FIG. 3. To facilitate discussion, these functional aspects are illustrated as encircled process modules with data being passed from one such process module to another in order to complete processing. Various types of commercially-available, bank-oriented computer-operating systems (with appropriately-defined computers, communication tools, firewalls, and memory databanks) can be programmed and configured in accordance with the following discussion to implement BE CPU system 304. It will also be appreciated that communications between these illustrated modules, depending on the application, might involve different types of computer-system configuration; a single independently-operated computer system; multiple computer arrangements having relatively independent operations; and computer systems having functional modules communicating with one another over a network such as a LAN or secured link carried by a publicly-available network (e.g., the Internet).

Flow begins in FIG. 3 with a customer-generated funds-transfer request being presented from a customer 306 to the nonbanking entity (agent) 302. The nonbanking entity 302 receives this request in the form of specific information, for example, name, residence address and passport (or driver's license) number of both sender (or requester) and of intended recipient, bank account number and amount of funds to be transferred. For example, the funds-transfer request can be a request for a money-wiring company to wire money from the customer's bank account at a Bank operated by BE CPU system 304. This information, in its entirety or in filtered form, is passed from the nonbanking entity 302 to a verification module 310 within the BE CPU system 304. The verification module 310 initially verifies that the requester is known to have the specified bank account number and sufficient funds for the requested transfer.

Such transaction information is then made available to other functional modules including a bank-accounting module 312 that is adapted to provide conventional authentication and record-keeping functions. This transaction information is also provided to a compliance processing module 314 that analyzes the funds-transfer request relative to a banking-directed rule set, such as guidelines imposed by bank-governing agencies for reporting funds-related activity. Examples of such activity reporting is a SAR (per the example illustrated) and/or a currency transaction activity report. In another example, the compliance processing module 314 is also adapted to analyze the transaction information for potentially suspicious transaction attributes, such as known or suspected embedded terrorist codes, recipient's country, senders citizenship, amount of transaction, frequency of transaction involving sender or recipient, etc.

In accordance with particular implementations of the present invention, thresholds are prestored and used as a reference for comparison to transaction attributes. For example, should the amount of a transaction exceed a predefined threshold, the compliance processing module 314 would flag the transaction for further processing by another module or by an investigator trained in this regard.

Such other modules include a second compliance processing module 316 and an assimilation processing module 318. With any necessary reconciliation provided by module 320 (as discussed above), the second compliance processing module 316 analyzes the funds-transfer request relative to a different, nonbanking-directed rule set, such as guidelines imposed by one of the other receiving entities discussed and illustrated in connection with FIG. 2. In a particular application, such nonbanking-directed rule sets may be dictated by the IRS, an international or foreign-government agency, or some other special agency having authoritative or influential power. It will be appreciated that such compliance might also be voluntary and pursuant to suggested guidelines provided by a consortium of cooperative and interested parties. In this context, the second compliance processing module 316 analyzes the transaction data much like the compliance processing module 314.

The assimilation processing module 318 determines whether the funds-transfer request raises a concern in view of the data output by one or both of the processing modules 314 and 316. In other more particular embodiments, the assimilation processing module 318 also analyzes this information to determine whether the funds-transfer request should be further monitored and/or analyzed in view of previous transaction histories (as is typically stored in CPU-accessible memory) and in view of concurrent and future transactions yet to be reported. For the latter, authorization (at 318) for the transfer of funds can be delayed. For any such analysis that raises a sufficient concern, as defined by the above-discussed or other guidelines and thresholds, the assimilation processing module 318 records the information and conclusion of the analysis and, where appropriate, reports such funds-related activity (e.g., suspicious activity and/or currency transaction activity) to the appropriate report receiving entities.

As indicated above, where the BE CPU system 304 is acting as an agent for a nonbanking entity, this reporting might have to be sent to multiple report receiving entities. Preferably, one such preferred report type is selected as the receiving entity and any other receiving entities are cross-referenced and/or copied via the same report. The following examples depict various situations that the BE CPU system 304, and its compliance-concern modules 314, 316 and 318, is configured and programmed to detect based on the above-characterized types of analyzes. Each such example assumes that a Banking Entity (“BE”) having multiple offices or locations and a Non-Banking Entity (“NBE” with its respective agents) have respective regulatory obligations to file SARs (Suspicious Activity Reports) for a combination of transactions that exceed a certain threshold, e.g., $3,000, in a given day. Further, each of the following hypotheticals assume that one person initiated all the transactions on the same day.
1. Customer initiates six (6) $1,000 money transfer transactions at six (6) separate NBE agents. None of the Agents is a BE-controlled office. NBE has obligation to file SAR. BE does not. CPU system 304 files SAR only on behalf of NBE as required by the dictating (e.g., IRS) government office.
2. Customer initiates six (6) $1,000 money transfer transactions at six (6) separate NBE agents. One of the Agents is a BE location. Customer initiates no other BE transactions that count toward the $3,000 reporting threshold. NBE has obligation to file SAR. BE does not. CPU system 304 files SAR only on behalf of NBE as required by the dictating (e.g., IRS) government office.
3. Customer initiates six (6) $1,000 money transfer transactions at six (6) separate NBE agents. Three (3) Agents are BE locations. Customer initiates no other BE transactions. NBE has obligation to file SAR. BE has obligation to file SAR in its capacity as Agent for NBE and in its capacity as a bank. CPU system 304 files SAR on behalf of both itself and NBE as required by the dictating government offices.
4. Customer initiates six (6) $1,000 monetary instrument transfer transactions (money orders, cashiers' checks, etc.) at six (6) separate BE locations. None of the transactions is a NBE money transfer transaction. BE has obligation to file SAR. NBE does not. CPU system 304 files SAR only on behalf of itself as required by the dictating government office.
5. Customer initiates six (6) $1,000 transactions at six (6) separate BE locations. Two (2) of the transactions are NBE money transfer transactions and the other four (4) are BE money orders, cashiers' checks, etc. NBE has no obligation to file SAR. BE has obligation to file SAR. CPU system 304 files SAR only on behalf of itself as required by the dictating government office.
6. Customer initiates six (6) $1,000 transactions. Three (3) of the transactions are NBE money transfers at Agent locations other than BE. The other three (3) transactions are BE money orders, cashiers' checks, etc. at BE locations. NBE has obligation to file SAR. BE has obligation to file SAR in its capacity as a bank. CPU system 304 files SAR on behalf of both itself and NBE as required by the dictating government offices.
7. Customer initiates four (4) $1,000 transactions. Two (2) of the transactions are NBE money transfers at Agent locations other than BE. The other two (2) transactions are BE money orders, cashiers' checks etc. at BE locations. Neither NBE nor BE has obligation to file SAR. CPU system 304 files no SAR or other external report.
8. Customer initiates four (4) $1,000 transactions. Two (2) of the transactions are NBE money transfers, one (1) of which is a BE location. The other two (2) transactions are BE money orders, cashiers' checks, etc., at BE locations. NBE has no obligation to file SAR. BE has obligation to file SAR in its capacity as Agent for NBE and in its capacity as a bank. CPU system 304 files SAR on behalf of both itself and NBE as required by the dictating government offices (reporting 1 NBE transfer and 2 other BE transactions).

A specific example of a relationship between a banking institution and a non-banking institution is a relationship between an educational account and a banking account. Such a relationship involves a wide assortment of considerations that can be addressed by an appropriate rule set.

In some instances, the educational institution is a government entity that is subject to appropriate regulations. In other instances, the educational institution is a private entity that may be subject to yet another set of regulations. As discussed herein, one level of tracking monitors transactions between the accounts, while another level of tracking monitors transactions dealing with the educational account alone, such as cash withdrawals, university purchases, online purchases, and retail purchases using the educational account (e.g., from retailers accepting educational accounts).

Educational institutions present other potential issues that can be addressed by implementing an appropriate rules set. For instance, some accounts may be held on behalf of minors (those not of legal age) or citizens of foreign states or countries. In other instances, the accounts may be linked to student loans provided by the educational institution, another banking institution or federal funds. The accounts could also be linked to scholarships provided by nonprofit organizations, companies, athletic based and similar sources. Such loans and scholarships often involve substantial amounts of money and periodic payments. These sources of income may also be subject to various restrictions on their use. For example, some federal loans have restrictions prohibiting the use of the loan for certain purchases (e.g., to finance real-estate investments). In some cases funds may originate from foreign governments or foreign companies, and thus, may require different tracking and reporting functions. In yet another instance, the accounts may be shared between a student and a parent or guardian. Thus, the account may be accessed by multiple individuals that have a special relationship creating the potential need for additional reporting rules.

According to one embodiment of the present invention, the banking institution and the educational institution can directly transfer funds between accounts held at the respective institutions. Such transfers can be initiated via automated teller machines (ATMs), Internet websites and other interfaces and the rule sets used for tracking can be adjusted accordingly. In another instance, an intermediary, such as a clearing house, can be used to move funds from one account to the other. Each method of access may carry additional tracking rule sets and other considerations.

According to another embodiment of the present invention, the tracking and reporting functions can be maintained by the banking institution. Often educational institutions exhibit lack of familiarity with the reporting requirements, computer system implementations of reporting and tracking, and the like. Thus, this can be particularly useful for reducing the burden on the educational institution. For instance, the banking institution may receive a transaction report/file from the educational institution. This transaction file contains details of the transactions carried out relative to the accounts held at the educational institution. The bank can examine the received transaction report relative to the pertinent rule set and generate the necessary reports. In some instances, it may be desirable to cross-reference or otherwise correlate accounts held at each institution. Performing the transaction analysis for each institution using the banking institution system can often facilitate such correlation.

In another embodiment of the present invention, tracking and reporting functions can be maintained by the educational institution. This can be in addition to any tracking or reporting functions carried out by the financial institution. This can be particularly useful for enabling the educational institution to have the flexibility to establish relationships with other financial institutions that may or may not have the capability to monitor and report suspicious activity relative to the educational institution's accounts.

While the present invention has been described with reference to several particular example embodiments, those skilled in the art will recognize that many changes may be made thereto without departing from the spirit and scope of the present invention. For example, many of the various examples and approaches above involve transactions between a single banking and a single non-banking institution. However, these approaches may be implemented with a multitude of such institutions and/or with other institutions, such as those implementing functions (and thus compliance rules) of both banking and non-banking institutions. While not limiting, examples of applicable banking financial transfer entities are interstate and intrastate-type national banks. Similarly not limiting, examples of non-banking financial transfer entities include educational institutions having debit accounts, electronic funds transfer-type, other wire transfer-type entities, and other non-electronic or non-wire transfer-type entities (e.g., stores that issue cashiers checks and currency exchange offices). One of the largest funds transfer companies is Western Union.

What is claimed is:

1. A computer-processing arrangement for processing funds-related activity involving a plurality of accounts at a banking institution and a plurality of accounts held at an educational institution, the plurality of accounts at the banking institution and the plurality of accounts held at the educational institution being associated with account holders common between the educational and banking institutions, the computer-processing arrangement comprising:
a data access circuit adapted to provide a bank-directed rule set for reporting funds-related activity involving the banking institution and another compliance rule set for reporting funds-related activity involving the educational institution;
a primary-entity processing module configured and programmed to analyze the funds-related activity relative to the bank-directed rule set;
a secondary-entity processing module configured and programmed to analyze the funds-related activity relative to the other compliance rule set; and
an assimilation processing module, responsive to the primary-entity processing module and the secondary-entity processing module, configured and programmed to correlate the funds-related activity relative to the banking institution and the educational institution and to determine based upon the results of the correlation whether to report the funds-related activity.

2. The computer-processing arrangement of claim 1 wherein the assimilation processing module is further configured and programmed to determine whether the funds-related activity corresponds to account holders common to both the banking institution and the educational institution.

3. The computer-processing arrangement of claim 1 wherein the funds-related activity includes transaction-identifying attributes that provide information about a funds-transfer request, and wherein the assimilation processing module is further configured and programmed to access transaction-identifying attributes for other funds transactions.

4. The computer-processing arrangement of claim 3 wherein the assimilation processing module is further configured and programmed to determine whether the funds-transfer request corresponds to funds-related activity as a function of the transaction-identifying attributes for the funds-transfer request corresponding to the transaction-identifying attributes for the other funds transactions.

5. The computer-processing arrangement of claim 4 wherein the assimilation processing module is further configured and programmed to determine that the funds-transfer request corresponds to the transaction-identifying attributes for the other funds transactions by reconciling differing transaction-identifying attributes based on one or more other transaction-identifying attributes.

6. The computer-processing arrangement of claim 1 wherein the assimilation processing module is further configured and programmed to determine whether funds-related activity for an account corresponds to funds-transfer requests related to the account.

7. The computer-processing arrangement of claim 1 wherein the assimilation processing module is used to provide a single report disclosing the funds-related activity for the plurality of accounts at a banking institution and the plurality of accounts held at an educational institution.

8. The computer-processing arrangement of claim 1 wherein the funds-related activity includes attributes that identify its sending and receiving parties, a funds amount, and a bank account maintained by the banking institution.

9. The computer-processing arrangement of claim 8 wherein the determination by the assimilation processing module of whether to report the funds-related activity is based on the attributes of the funds-related activity.

10. The computer-processing arrangement of claim 1 wherein the other compliance rule set is based on government-provided guidelines for the educational institution.

11. The computer-processing arrangement of claim 1 wherein the other compliance rule set is based on government-provided guidelines for the educational institution, and wherein the banking institution is acting as an agent with obligations to report funds-related activity on behalf of the educational institution.

12. A computer-based method for processing a funds-transfer request for an account held at an educational institution through a banking institution, the computer-based method comprising:
accessing a bank-directed rule set for reporting funds-related activity involving a banking institution and another compliance rule set for reporting funds-related activity involving the educational institution;
analyzing the funds-transfer request relative to the bank-directed rule set;
analyzing the funds-transfer request relative to the other compliance rule set; and
determining, in response to the analyzed funds-transfer request, whether the funds-transfer request should be reported as at least one of funds-related activity involving the banking institution and funds-related activity involving the educational institution.

13. The method of claim 12 wherein determining whether the funds-transfer request should be reported further comprises determining whether the funds-transfer request corresponds to a funds-related activity involving both the banking institution and the educational institution.

14. The method of claim 12 wherein processing the funds-transfer request includes processing transaction-identifying attributes that provide information about the funds-transfer request, and wherein determining whether the funds-transfer request should be reported is based on processed transaction-identifying attributes for other funds transactions.

15. The method of claim 14 wherein determining whether the funds-transfer request should be reported further comprises determining the transaction-identifying attributes for the funds-transfer request that correspond to the transaction-identifying attributes for the other funds transactions.

16. The method of claim 15 wherein determining whether the funds-transfer request should be reported further comprises reconciling differing transaction-identifying attributes based on one or more other transaction-identifying attributes.

17. The method of claim 12 wherein determining whether the funds-transfer request should be reported comprises determining whether the funds-transfer request corresponds to funds-related activity, or other funds-transfer requests.

18. The method of claim 12 further comprising, in response to determining whether the funds-transfer request should be reported, providing a single report disclosing the funds-related activity of both the educational institution and the banking institution.

19. The method of claim 12 wherein processing the funds-transfer request includes processing attributes that identify its sending and receiving parties, a funds amount, and a bank account maintained by the banking institution.

20. The method of claim 19 wherein the determination of whether the funds-transfer request should be reported is based on the processing attributes of the funds-transfer request.

21. The method of claim 12 wherein the other compliance rule set is based on government-provided guidelines for the educational institution.

22. The method of claim 12 wherein the other compliance rule set is based on government-provided guidelines for the educational institution, and wherein the banking institution is acting as an agent with obligations to report funds-related activity on behalf of the educational institution.

23. A computer-processing arrangement for processing funds-related activity involving a plurality of accounts at a banking institution and a plurality of accounts held at an educational institution, the plurality of accounts at the banking institution and the plurality of accounts held at the educational institution being associated with account holders common between the educational and banking institutions, the computer-processing arrangement comprising:
means for providing a bank-directed rule set for reporting funds-related activity involving the banking institution and another compliance rule set for reporting funds-related activity involving the educational institution;
a first processing means for analyzing the funds-related activity relative to the bank-directed rule set;
a second processing means for analyzing the funds-related activity relative to the other compliance rule set; and
an assimilation processing means, responsive to the first processing means and the second processing means, for correlating the funds-related activity relative to the banking institution and the educational institution and for determining based upon the results of the correlation whether to report the funds-related activity.
